(19) United States
(12) Patent Application Publication
(10) Pub. No.: US 2025/0244835 A1
(43) Pub. Date: Jul. 31, 2025

(54) DIGITAL PEN

(71) Applicant: C. JOSEF LAMY GMBH, Heidelberg (DE)

(72) Inventor: Sebastian ZIELONKA, Viernheim (DE)

(73) Assignee: C. JOSEF LAMY GMBH, Heidelberg (DE)

(21) Appl. No.: 19/037,801

(22) Filed: Jan. 27, 2025

(30) Foreign Application Priority Data
Jan. 26, 2024 (DE) 10 2024 102 301.5

(51) Int. Cl. G06F 3/0354; G06F 3/044; G06F 3/046

(52) U.S. Cl. CPC G06F 3/03545; G06F 3/0441; G06F 3/046

(57) ABSTRACT

A digital pen with an elongate pen part which has a front pen portion with a writing element for writing on a surface such as paper or a touchscreen, and a pen portion which is arranged further back in relation to the front pen portion and in which—in whole or in part—a rechargeable battery is arranged for supplying power to at least one electronic component of the front pen portion, and a (separable) protective cap. The invention is characterized in that the protective cap is designed in such a way and in a charging connection state, in which it can be detachably attached to the pen part, is coupled to the rechargeable battery in such a way that charging energy transferred to the protective cap from a charging source for charging the rechargeable battery is retransmitted to the latter or can be retransmitted.

The present invention relates to a digital pen with an elongate pen part which has a front pen portion with a writing element, in particular designed as a writing tip, for writing on a surface such as paper or a touchscreen, and a pen portion which is arranged further back in relation to the front pen portion, in particular has a housing, and in which—in whole or in part-a rechargeable battery, which is in particular elongate, is arranged for supplying power to at least one electronic component of the front pen portion, and a (separable), in particular elongate, protective cap.

Such digital pens with rechargeable batteries are known. To recharge the rechargeable battery, a receiving means in the form of electrical contacts is provided on the elongate pen part and is electrically connected to the rechargeable battery and can be connected in a wired manner (via a cable, etc.) to an external voltage or charging source if necessary. If the receiving means is damaged, however, the entire digital pen, including the expensive electronics it contains, often has to be disposed of, which is disadvantageous.

It is the object of the present invention to further develop the aforementioned digital pen.

This object is achieved by a digital pen having the features of claim 1. The invention is therefore characterized in that the protective cap is designed in such a way and in a charging connection state, in which it is detachably attached to the pen part, in particular in a frictionally engaged and/or form-fitting manner, for example by a screw, snap or bayonet connection, is coupled to the rechargeable battery in such a way that charging energy transferred to the protective cap from a charging source, in particular an electrically operated charging source, for charging the rechargeable battery is retransmitted to the latter or can be retransmitted.

Preferably, the protective cap can comprise a receiving means to which the charging energy of the charging source can be transmitted in a wired manner or wirelessly. In particular, either by in a wired manner by means of electric current or wirelessly inductively, capacitively or by means of electromagnetic waves.

In other words, the protective cap of the digital pen is used to charge the rechargeable battery in the digital pen. One of the advantages of this is that only the protective cap would need to be replaced if the receiving device were to become defective. The cost-intensive pen part could continue to be used.

The receiving means can be formed by contacts to which the charging source can supply electric charging current to charge the rechargeable battery. In particular, by means of electric contacts that are components of an interface arranged on the protective cap for the detachable connection of a power cable or a power and data cable that is connected or can be connected to the charging source.

However, the receiving means can also comprise a unit for inductive or capacitive reception of the charging energy or a unit for receiving electromagnetic waves transmitted by the charging energy, so that the charging energy is transmitted to it wirelessly or in a non-wired manner.

In the charging connection state of the protective cap and pen part, the receiving means of the protective cap can be coupled to the rechargeable battery wirelessly, in particular inductively, capacitively or by means of electromagnetic waves, and/or in a wired manner to pass the charging energy transferred to the receiving means on to the rechargeable battery.

The protective cap for (wirelessly) transmitting the charging energy to the rechargeable battery can have a transmitting unit, in particular comprising a transmitting coil, of an inductive energy transmission device of the digital pen, which transmitting unit is connected to the receiving means of the protective cap, in particular the electrical contacts, in a wired manner.

The pen part, in particular the front pen portion or a or the pen portion arranged further back, can have a receiving unit, in particular comprising a receiving coil, of the inductive energy transmission device of the digital pen, which receiving unit is connected to the rechargeable battery in a wired manner and interacts inductively with the transmitting unit in order to transmit the charging energy for charging the rechargeable battery to the receiving unit.

The electrical contacts of the protective cap forming the receiving means can, in the charging connection state of the protective cap and pen part, be connected in a wired manner to electrical contacts arranged on the pen part, in particular on the front pen portion or on the pen portion arranged further back, which electrical contacts in turn are electrically conductively connected to the rechargeable battery.

The electrical contacts of the receiving means of the protective cap, which are arranged further forward in particular, can be connected in a wired manner to additional electrical contacts of the protective cap, which are arranged further back in particular, wherein the additional electrical contacts of the protective cap make contact with the electrical contacts of the pen part, which are electrically conductively connected to the rechargeable battery, in the connection state of the protective cap and pen part.

The receiving means of the protective cap can in turn be arranged on a (front) end face of the protective cap or on a, in particular circumferential, outer face of the same.

The electronic component that can be supplied with power by the rechargeable battery can be the writing element of the digital pen or a component for operating the writing element.

In the charging connection state in which it is detachably attached to the pen part, the protective cap of the digital pen can cover the writing element and at least a sub-portion of the front pen portion or a or the pen portion arranged further back, preferably comprising the (rear) free end of the pen part.

In the event that the protective cap covers the pen portion arranged further back in the charging connection state, the protective cap can be detachably fastened to the pen part in a further position in which it covers the writing element and at least a sub-portion of the front pen portion.

It can also be provided that, to remove the rechargeable battery, the pen portion arranged further back is detachably attached to another pen portion, in particular the front pen portion. This is preferably achieved by means of a screw, snap or bayonet connection, in particular in such a way that the rechargeable battery, in a state of the pen portion arranged further back in which the latter is detached from the other pen portion, can be removed from the pen portion arranged further back via an opening thereof that faces the other pen portion. Alternatively or additionally, it can be provided that, to remove the rechargeable battery, the rechargeable battery is arranged detachably in the pen portion arranged further back.

The rechargeable battery can have at least two electrical contacts, via which the rechargeable battery can be supplied with electrical charging current.

One or both of the electrical contacts of the rechargeable battery can be arranged in the region of the front end of the rechargeable battery facing the writing element and/or adjacent to this end. Alternatively or additionally, one or both of the electrical contacts of the rechargeable battery are arranged in the region of the rear end of the rechargeable battery facing away from the writing element or adjacent to this end.

Both electrical contacts of the rechargeable battery, via which this electrical charging current can be supplied, can each be detachably electrically connected to an electrical contact of the front pen portion, which is electrically conductively connected to the electronic component of the front pen portion, namely for supplying power to the electronic component.

In the event that the two electrical contacts of the rechargeable battery for supplying the charging current are arranged in the region of the rear end of the rechargeable battery facing away from the writing element or adjacent to this end, in the region of the front end facing the writing element or adjacent to this end, the rechargeable battery can have two further electrical contacts for supplying power to the electronic component of the front pen portion, each of which is detachably electrically connected to its own electrical contact of the front pen portion which is connected in a current-conducting manner to the electronic component of the front pen portion.

Each of the two electrical contacts of the rechargeable battery for supplying the charging current or each of the two electrical contacts of the rechargeable battery for supplying power to the electronic component can be part of a plug connector part, in particular a common plug connector part, in particular a plug connector part to which there is connected (at least) one power line preferably in the form of a power cable, which is electrically connected to one of the two terminals of the rechargeable battery.

The or each plug connector part can be detachably connected, forming an electrical plug connection, to a plug connector mating part which has an electrical contact of the front pen portion. In particular an electrical contact via which charging current can be supplied to the rechargeable battery and/or via which supply current from the rechargeable battery can be supplied to the electronic component of the front pen portion.

Each of the two electrical contacts of the rechargeable battery can, for supplying the charging current, or each of the two electrical contacts of the rechargeable battery can, for supplying power to the electronic component, comprise or be formed by a contact surface arranged directly on the rechargeable battery, in particular on its battery housing, preferably forming one of the terminals of the rechargeable battery, in particular a contact surface made of electrically conductive material.

One of the contact surfaces can form the positive terminal of the rechargeable battery and the other contact surface can form the negative terminal of the rechargeable battery.

One or both contact surfaces can be arranged on an end face of the rechargeable battery, in particular a flat end face, which preferably extends at an angle, in particular transversely, to the longitudinal axis of the pen part and forms the front free end of the rechargeable battery.

One or both contact surfaces can be annular and/or one contact surface can form the circumferential inner side of a hollow-cylindrical portion of the rechargeable battery.

The two annular contact surfaces can be arranged concentrically.

The pen portion arranged further back can have a particularly elongate, preferably hollow-cylindrical receiving space in which the rechargeable battery is arranged in a fully or partially detachable manner, in particular with sliding contact against a circumferential receiving space wall that laterally delimits the receiving space.

The pen part, in particular the front or rear pen portion, may comprise an electronic module for managing the charging process of the rechargeable battery, in particular an electronic module for managing the charging process, which is electrically connected in a wired manner to the two electrical contacts of the rechargeable battery for supplying the charging current.

With regard to the protective cap of the pen, it can be detachably attached to the pen part preferably in a frictionally engaged and/or form-fitting manner, in particular by a screw, snap or bayonet connection and/or it can be designed to protect the writing element against damage during transport of the digital pen, and/or it can have a clip for attaching the digital pen to objects such as paper or clothing.

Further features of the present invention can be found in the appended claims, in the following description of preferred exemplary embodiments and in the appended drawings, in which:

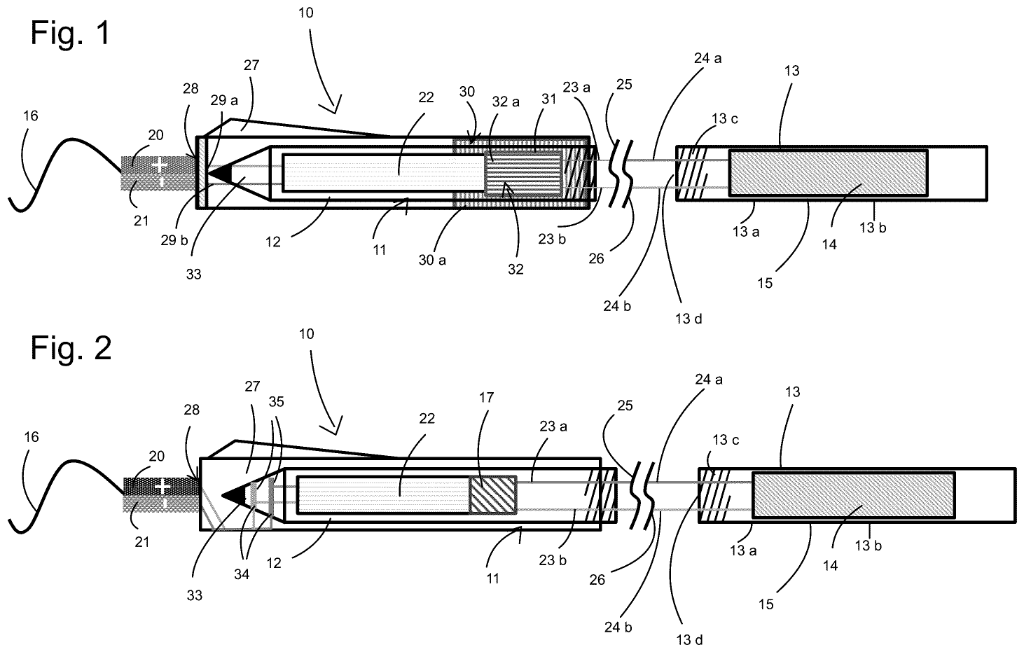

FIG. 1 shows a principle sketch (longitudinal section) of a first embodiment of a digital pen, in which the charging energy for the rechargeable battery is supplied to a protective cap, which sits on a front pen portion of a pen part of the digital pen and forwards thus in a wired manner or wirelessly to the pen part, namely to the front pen portion,

FIG. 2 shows a schematic sketch (longitudinal section) of a second embodiment of a digital pen, in which the protective cap likewise sits on the front pen portion and forwards the charging energy in a wired manner to the front pen part,

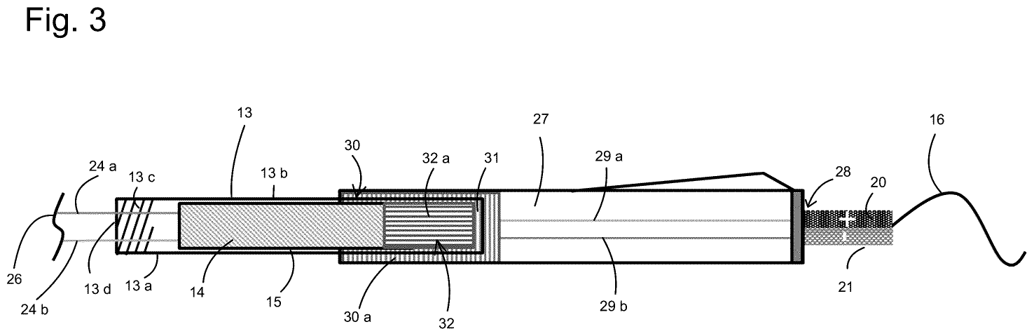

FIG. 3 shows a schematic sketch (longitudinal section) of a third embodiment of a digital pen, in which the protective cap sits on a pen portion of the pen part arranged further back and forwards the charging energy in a non-wired manner or wirelessly to the pen portion arranged further back,

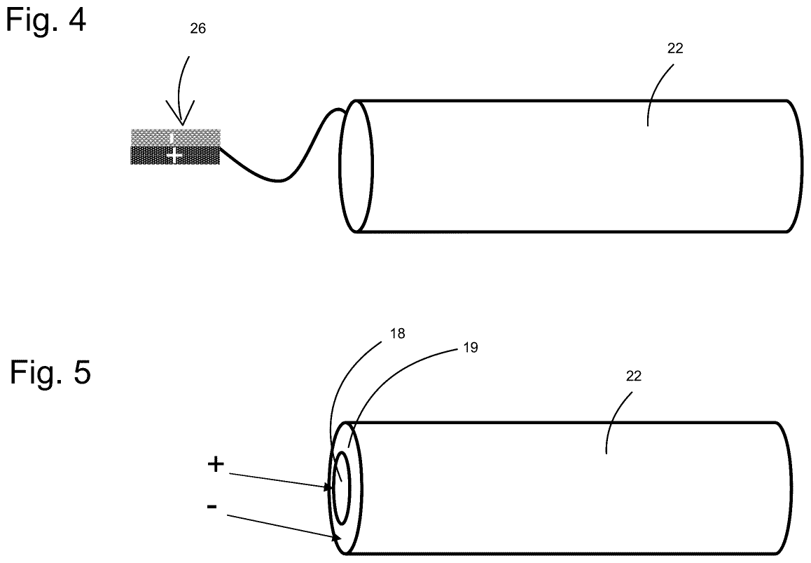

FIG. 4 shows a schematic sketch (oblique view) of a first embodiment of a removable, rechargeable battery of the digital pen, with two electrical (connection) contacts connected to the terminals of the rechargeable battery via a power cable for detachable connection of the rechargeable battery to electrical (mating) contacts of the digital pen,

FIG. 5 shows a schematic sketch (oblique view) of a second embodiment of a removable, rechargeable battery of the digital pen, with two annular contact surfaces formed by the battery terminals for detachable connection with electrical (mating) contacts of the digital pen.

The drawings show various exemplary, simplified sketched embodiments of a digital pen 10 as it could be implemented in accordance with the core ideas of the present invention. It is understood that the invention is not limited to these embodiments.

The digital pen 10 shown has an elongate pen part 11, which comprises a front pen portion 12 and a pen portion 13 arranged further back. According to the invention, the digital pen 10 can be based on any known technology for such digital input pens or use any known technology. For example, it can be an electromagnetic, electro-optical, EMR, capacitive, inductive or resistive digital pen.

The front pen portion 12 has a writing element 33, in this case in the form of a writing tip, for writing on a surface such as paper or a touchscreen.

A rechargeable (in the present case cylindrical) battery 14 is located in a, for example, hollow-cylindrical receiving space 15 of the pen portion 13 arranged further back. During operation of the digital pen 10, this battery 14 is used to supply at least one electronic or electrically operated component 22 located in the front pen portion 12 (in the context of the present application, such a component can also be understood as an assembly of several electronic/electrical components) of the digital pen 10 with electrical current. In the case of an electro-optical pen, this could be, for example, an LED and/or a camera to determine the position of the pen; in the case of an electromagnetic pen, a generator of an electromagnetic field, etc.

In order to be able to replace the rechargeable battery 14 with a new rechargeable battery at the end of its service life, for example, or to be able to dispose of it separately in the event that the digital pen 10 becomes defective, the rechargeable battery 14 is detachably arranged or stored in the pen portion 13 arranged further back or in a receiving space 15.

For this purpose, it can be provided that the outer contour of the rechargeable battery 14 is adapted to the receiving space 15, for example, in such a way that walls, projections or the like delimiting the receiving space 15 ensure a secure hold in the pen part 11 or the pen portion 13 arranged further back, so that the rechargeable battery 14 does not have to be protected from disruptive relative movements within the receiving space 15 by non-detachable bonding or the like.

In this context, it may be provided that the rechargeable battery 14 rests only slidingly and thus easily removably against a circumferential wall delimiting the receiving space 15, so that it can be moved out of the pen portion 13 arranged further back by a user by corresponding relative movement in the axial direction.

In the present case, for this purpose, it is in sliding contact with a housing wall 13 b of a housing 13 a of the pen portion 13 arranged further back, which delimits the receiving space 15.

Furthermore, the pen portion 13 arranged further back is detachably attached to the front pen portion 12 at an end portion 13 c facing the front pen portion 12, for example by means of a screw, snap or bayonet connection

Accordingly, the pen portion 13 arranged further back can then be detached from the front pen portion 12 if necessary and the rechargeable battery 14 can be removed from the pen portion 13 arranged further back via a front opening 13 d arranged at the end face of the end portion 13 c.

In the present case, the pen portion 13 arranged further back also forms the rear, free end of the pen part 11. However, it is of course also theoretically conceivable that the pen portion 13 arranged further back does not form the rear, free end and is detachably connected, for example, to an additional pen portion arranged even further back (in particular comprising the rear, free end of the pen part). In this case, it could also be provided that the rechargeable battery 14, which is detachably arranged in the pen portion 13 arranged further back, is removed via an opening of the pen portion 13 arranged further back, which faces the additional pen portion. A wide variety of variants are conceivable here.

For charging the rechargeable battery 14, solutions are shown in FIGS. 1-2 in which the electrical charging energy required for this is supplied via the front pen portion 12. In the embodiments in FIG. 3, on the other hand, the electrical charging energy is supplied via the pen portion 13 arranged further back.

In the embodiment shown in FIG. 1, it is intended to supply the charging energy initially in a wired manner to a protective cap 27 of the digital pen 10, namely in the present case by means of a (at least two-wire) power line or a power cable 16.

The protective cap 27 has a receiving means 28, which in the present case is formed by (at least two) electrical connection contacts (not shown), which in the present case are arranged on the end face of the protective cap 27 (they could of course also be arranged on the circumferential side of the protective cap) and can be (but do not have to be) part of an interface, for example, which may have further contacts, for example for transmitting data.

In the present case, mating contacts 20, 21 can be detachably electrically connected to the electrical connection contacts of the receiving means 28 and can, for example, be part of a plug part and are attached to a power cable 16 leading to/carrying charging energy to a charging source 16 (not shown). The charging source can, for example, be a conventional voltage source.

The electrical connection contacts of the receiving means 28, which can be connected or are connected to the mating contacts 20, 21, are connected by means of connecting lines 29 a, 29 b in a current-conducting or wired manner to a transmitting unit 30 of the protective cap 27 of a device of the digital pen 10 for the wireless or wired transmission of charging energy. This device can then be used to transmit charging energy, which is transmitted from the charging source to the protective cap 27, from the protective cap 27 to the pen part 11, namely in this case to the front pen portion 12, wirelessly or in a wired manner.

In the charging connection state shown in FIG. 1, the protective cap 27 is detachably attached for this purpose to the pen part 11, namely to the front pen portion 12, and in the present case is plugged onto the front end of the pen portion 12.

The type of detachable attachment of the protective cap 27 to the pen part 11 is not important. The protective cap 27 can, for example, be attached in a frictionally engaged and/or form-fitting manner.

In the charging connection state, the rear, free end of the front pen portion 12 comes to rest in a receiving portion 31 of the protective cap 27.

The transmitting unit 30 of the protective cap 27 is then arranged in the region of the receiving portion 31 and surrounds the rear, free end of the front pen portion 12, so that a receiving unit 32 of the device for the wireless transmission of charging energy, which is a component of the pen part 11 or of the front pen portion 12, is surrounded by the transmitting unit 30.

In the present case, the charging energy is transmitted inductively between the transmitting unit 30 and the receiving unit 32, but it could also be transmitted capacitively or by means of electromagnetic waves.

For inductive transmission, the transmitting unit 30 accordingly has a transmitting coil 30 a known per se and the receiving unit 32 has a receiving coil 32 a known per se.

In the further course, the receiving coil 32 a is connected to the rechargeable battery 14 in the pen part 11 in a wired manner, so that the charging energy that it receives can be passed on to the rechargeable battery 14 as electric current. In the present example, this is done via power lines 23 a, 23 b, 24 a, 24 b (for example in cable form), which are detachably connected to each other via detachable (electrical) connecting contacts 25 or 26.

The connecting contacts 26 can, for example, comprise a plug with connection contacts, which is connected in a wired manner, in this case via the power lines 24 a, 24 b, to charging contacts of the rechargeable battery 14, in particular the terminals of the rechargeable battery 14, which are not shown. An example of a rechargeable battery 14 with corresponding connecting contacts 26 is shown in FIG. 4. In the present case, the charging contacts of the rechargeable battery 14 are arranged at its front end, but this does not necessarily have to be the case.

It is also conceivable to dispense with the power lines 24 a, 24 b and the connecting contacts 26. For example, the rechargeable battery 14 could have contact surfaces 18, 19 at its end facing the front pen portion 12, as shown in FIG. 4, which are in direct contact with the connecting contacts 25.

The contact surfaces 18, 19 can, for example, be designed as, in particular, concentric, ring-shaped contact surfaces 18, 19 made of electrically conductive material. These contact surfaces 18, 19 are preferably formed directly by a corresponding negative and positive terminal of the rechargeable battery 14 and lie detachably against the electrical connection contacts 25.

It is understood that a wide variety of variants are conceivable here.

In the present case, the electrically operated component 22 is also supplied with power via the charging contacts of the rechargeable battery 14. The charging contacts are also connected to the electrically operated component 22 in a correspondingly wired manner.

The charging contacts therefore also serve as power supply contacts. However, this does not have to be the case. It is also conceivable that the rechargeable battery 14 has separate power supply contacts, which are then connected with the electrical component 22 in a current-conducting and preferably detachable manner.

The rechargeable battery 14 can also be detachably and electrically conductively connected to a charging management module, not shown in FIG. 1, which optimizes the charging process and which is also coupled or connected to the receiving means 28 of the digital pen 10. It is understood that a charging management module is not absolutely necessary.

To remove the rechargeable battery 14, in the exemplary embodiment of FIG. 1, a user can detach the pen portion 13 which is arranged further back from the front pen portion 12 and can detach the connecting contacts 25 from the connecting contacts 26. The user can then remove the rechargeable battery 14 from the pen portion 13 arranged further back.

FIG. 2 shows an embodiment of a digital pen 10 which differs from the embodiment in FIG. 1 in that, unlike the embodiment in FIG. 1, the transfer of the charging energy from the protective cap 27 to the front pen portion 12 is not wireless or non-wired.

Rather, the connection contacts forming the receiving means 28 and arranged on the protective cap 27 are connected to the rechargeable battery 14 in the illustrated charging connection state of the protective cap 27 in a wired manner throughout, including via the power lines 23 a, 23 b and 24 a, 24 b, respectively. In this case, the connection contacts of the receiving means 28 are initially connected in a wired manner to further electrical contacts 34 arranged on the protective cap 27, which in turn are connected in a wired manner to electrical contacts 35 arranged on the front pen portion 12, which are suitably opposite in this state, as a result of the respective opposite contacts 34 and 35 touching each other.

An intermediate charging management module 17 is also recognizable in FIG. 2.

The embodiment of FIG. 3 differs from the embodiment of FIGS. 1 and 2 in that the protective cap 27 is not detachably plugged or seated on the front pen portion 12, but instead is detachably attached to the pen portion 13 arranged further back.

In this case, the receiving unit 32, in particular the receiving coil 32 a, can be connected in a wired manner to the charging contacts of the rechargeable battery 14 arranged at the rear end of the rechargeable battery 14.

Separate power supply contacts can be arranged at the front end of the rechargeable battery 14, which are then electrically conductively connected to the electrically operated component 22 via the power lines 23 a, 23 b or 24 a, 24 b. A charging management module 17 can also be connected in between here.

It should be noted that the protective cap 27 is generally detachably connectable to the pen portion 11 not only in the position shown in FIG. 3, in which it is plugged onto the pen portion 13 arranged further back in the charging connection state, but also in a further protective position, in which it sits on the front pen portion 12 and covers the writing element 33 (and at least a sub-portion of the front pen portion 12) to protect the writing element 33 (this corresponds to the charging connection state of the protective cap 27 in the embodiments of FIGS. 1 and 2).

It should also be noted that in all the embodiments shown, the electrical charging energy is transmitted from the charging source to the respective receiving means 28 of the protective cap 27 of the digital pen 10 in a wired manner. However, this does not necessarily have to be the case. Rather, the charging energy could also be transmitted wirelessly, in particular inductively, capacitively or by means of electromagnetic waves.

### LIST OF REFERENCE SIGNS

10 digital pen
11 pen part
12 front pen portion
12 a housing
13 pen portion arranged further back
13 a housing
13 b housing wall
13 c end portion
13 d front opening
14 rechargeable battery
15 receiving space
16 power cable
17 charging management module
18 contact surface
19 contact surface
20 mating contact
21 mating contact
22 electrically operated component
23 a power line
23 b power line
24 a power line
24 b power line
25 connecting contacts
26 connecting contacts
27 protective cap
28 receiving means
29 a connecting line
29 b connecting line
30 transmitting unit
30 a transmitting coil
31 receiving portion
32 receiving unit
32 a receiving coil
33 writing element
34 contacts
35 contacts

1. A digital pen with an elongate pen part which has a front pen portion with a writing element for writing on a surface such as paper or a touchscreen, and a pen portion which is arranged further back in relation to the front pen portion and in which—in whole or in part—a rechargeable battery is arranged for supplying power to at least one electronic component of the front pen portion, and a (separable wherein the protective cap is designed in such a way and in a charging connection state, in which it can be detachably attached to the pen part, is coupled to the rechargeable battery in such a way that charging energy transferred to the protective cap from a charging source for charging the rechargeable battery is retransmitted to the latter or can be retransmitted.

2. The digital pen as claimed in claim 1, wherein the protective cap has a receiving means to which the charging energy of the charging source can be transmitted in a wired or wireless manner.

3. The digital pen as claimed in claim 2, wherein the receiving means is formed by contacts to which the electric charging current of the charging source can be supplied in order to charge the rechargeable battery.

4. The digital pen as claimed in claim 2, wherein the receiving means comprises a unit for inductive or capacitive reception of the charging energy or a unit for receiving electromagnetic waves that transmit the charging energy.

5. The digital pen as claimed in claim 1, wherein the receiving means of the protective cap is coupled to the rechargeable battery in the charging connection state of the protective cap and pen part wirelessly and/or in a wired manner, so that the charging energy transmitted to the receiving means is passed on to the rechargeable battery.

6. The digital pen as claimed in claim 5, wherein the protective cap for transmitting the charging energy to the rechargeable battery has a transmitting unit of an inductive energy transmission device of the digital pen, which transmitting unit is connected in a wired manner to the receiving means of the protective cap.

7. The digital pen as claimed in claim 6, wherein the pen part has a receiving unit of the inductive power transmission device of the digital pen, which receiving unit is connected to the rechargeable battery in a wired manner and interacts inductively with the transmitting unit in order to transfer the charging energy to the receiving unit for charging the rechargeable battery.

8. The digital pen as claimed in claim 1, wherein the electrical contacts of the protective cap forming the receiving means are connected in a wired manner in the charging state of the protective cap and pen part to electrical contacts arranged on the pen part part which in turn are electrically conductively connected to the rechargeable battery.

9. The digital pen as claimed in claim 8, wherein the electrical contacts of the receiving means of the protective cap, which are arranged in particular further forward, are connected in a wired manner to additional electrical contacts of the protective cap, which are arranged in particular further back, wherein the additional electrical contacts of the protective cap in the connected state of the protective cap and the pen part are in contact with the electrical contacts of the pen part, which are electrically conductively connected to the rechargeable battery.

10. The digital pen as claimed in claim 1, wherein the receiving means of the protective cap is arranged on a end side of the protective cap or on an outer side thereof.

11. The digital pen as claimed in claim 1, wherein the electronic component that can be supplied with power by the rechargeable battery is the writing element or a component for operating the writing element.

12. The digital pen as claimed in claim 1, wherein the protective cap, in the charging connection state, in which it is detachably attached to the pen part, covers the writing element and at least a sub-portion of the front pen portion or a or the rear pen portion arranged further back.

13. The digital pen as claimed in claim 12, wherein in the event that the protective cap covers the pen portion arranged further to the rear in the charging connection state, the protective cap can be detachably fastened to the pen part in a further position in which it covers the writing element and at least a sub-portion of the front pen portion.

14. The digital pen as claimed in claim 1, wherein the pen portion arranged further back for removing the rechargeable battery can be detachably fastened to another pen portion.

15. The digital pen as claimed in claim 1, wherein the rechargeable battery has at least two electrical contacts via which the rechargeable battery can be supplied with electric charging current.

16. The digital pen as claimed in claim 15, wherein one or both of the electrical contacts of the rechargeable battery are arranged in the region of the front end of the rechargeable battery facing the writing element or adjacent to this end, and/or wherein one or both of the electrical contacts of the rechargeable battery are arranged in the region of the rear end of the rechargeable battery facing away from the writing element or adjacent to this end.

17. The digital pen as claimed in claim 15, wherein both electrical contacts of the rechargeable battery, via which this electrical charging current can be supplied, can each be detachably electrically connected to an electrical contact of the front pen portion, which is electrically conductively connected to the electronic component of the front pen portion, namely for supplying power to the electronic component.

18. The digital pen as claimed in claim 15, wherein in the event that the two electrical contacts of the rechargeable battery for supplying the charging current are arranged in the region of the rear end of the rechargeable battery facing away from the writing element or adjacent to this end, in the region of the front end facing the writing element or adjacent to this end, the rechargeable battery has two further electrical contacts for supplying power to the electronic component of the front pen portion, each of which is detachably electrically connected to its own electrical contact of the front pen portion which is connected in a current-conducting manner to the electronic component of the front pen portion.

19. (canceled)

20. (canceled)

21. The digital pen as claimed in claim 15, wherein each of the two electrical contacts of the rechargeable battery for supplying the charging current or each of the two electrical contacts of the rechargeable battery for supplying power to the electronic component comprises or is formed by a contact surface arranged directly on the rechargeable battery.

22. (canceled)

23. (canceled)

24. The digital pen as claimed in claim 21, wherein one or both contact surfaces are annular and the two annular contact surfaces are arranged concentrically, and/or wherein one contact surface forms the circumferential inner side of a hollow-cylindrical portion of the rechargeable battery.

25. (canceled)

26. (canceled)

27. The digital pen as claimed in claim 1, wherein the pen part comprises an electronic module for managing the charging process of the rechargeable battery, which is electrically connected in a wired manner to the two electrical contacts of the rechargeable battery for supplying the charging current.

28. The digital pen as claimed in claim 1, wherein the protective cap is detachably attachable to the pen part, and/or wherein the protective cap is designed to protect the writing element against damage during transport of the digital pen, and/or wherein the protective cap has a clip for attaching the digital pen to objects, such as paper or clothing.
